(19) United States
(12) Patent Application Publication
(10) Pub. No.: US 2008/0134346 A1
(43) Pub. Date: Jun. 5, 2008

(54) Transactions Certification Method And System To Protect Privacy On Details Of Electronic Transactions

(76) Inventors: Yeong-Sub Cho, Daejeon-city (KR); Jong-Hyouk Noh, Daejeon-city (KR); Sang-Rae Cho, Daejeon-city (KR); Dae-Seon Choi, Daejeon-city (KR); Taesung Kim, Deajeon-city (KR); Seung-Hyun Kim, Daejeon-city (KR); Seung-Hun Jin, Daejeon-city (KR); Do-Won Hong, Daejeon-city (KR); Kyo-Il Chung, Daejeon-city (KR); Sung-Won Sohn, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/573,175

(22) PCT Filed: Dec. 13, 2004
(86) PCT No.: PCT/KR04/03266

§ 371 Date: Jun. 26, 2007

(30) Foreign Application Priority Data
Aug. 5, 2004 (KR) 10-2004-0061672

(51) Int. Cl. G06F 7/04

(52) U.S. Cl. 726/29

(57) ABSTRACT

Provided are a transactions certification method and system to protect privacy on details of electronic transactions, the method comprising the operations of: a) receiving and registering client information which is encoded so that a client cannot be identified; b) receiving and storing transactions details of a client including a client transactions identifier encoded by the service provider server; c) after receiving client certification information for client certification, performing client certification by comparing the client information previously registered in the operation a) with the received client certification information; d) receiving a client transactions identifier for searching transactions details of a client when the client certification is performed in the operation c), and determining whether the client transactions identifier and the client transactions identifier previously stored in the operation b) are identical with each other; and c) generating a message corresponding to the transactions details of the client and sending the generated message to the client when it is determined that the client transactions identifiers are identical with each other in the operation d). Accordingly, the transactions details can be managed while protecting privacy on the transactions details of the client.

### TECHNICAL FIELD

The present invention relates to a transactions certification method and system to protect privacy on details of electronic transactions, and more particularly, to a transactions certification method and system to protect privacy of a client by preventing a transactions certification institution from identifying which client has conducted transactions, the transactions certification institution storing transactions details of the client which are supplied from a service provider server, and accordingly, the method and system can be conveniently used to manage transactions details by enabling the client to inquire about the transactions details at any time.

### BACKGROUND ART

With the development and widespread use of the Internet, electronic transactions are rapidly becoming commonplace, and accordingly, users are provided with various services by many on-line service providers. However, since there are many different service providers, the users cannot easily inquire and manage the transactions details about the used services. Accordingly, whenever a user uses this type of services, service transactions details are sent to a transactions certification institution, i.e., a trusted third party, and managed through the transactions certification institution and then the user can inquire about the service transactions details at the transactions certification institution.

However, the transactions certification institution may become aware which user performs what kind of transactions from the details of the transactions, and thereby the user's privacy infringement may occur. Hence, it is an important problem that while a transactions certification institution manages details of typical transactions conducted between a user and a service provider, the transactions certification institution does not infringe the user's privacy through the transactions details.

Conventionally, a service provider uses PET (privacy enhancing technology) to improve protection of user's privacy. Further, a study for preventing abuse and misuse of personal information by adapting P3P (platform for privacy preference) which is used as a standard of a protocol and personal information protection policy which indicates user's prior consent of flow and exchange of information between a web server of a service provider and a user's web browser has been researched.

Korean patent laid-open publication No. 10-2001-0107564 (entitled ‘Method and System for Commerce with Full Anonymity’) discloses a method of concealing identification information of a user, who participates in electronic commerce from a service provider. In this publication, there is a third party between a user and a service provider which conduct transactions, and after the third party changes identification information received from the user to anonymous information, the third party provides the changed information to the service provider, thereby avoiding identification of the user to the service provider.

### DISCLOSURE OF INVENTION

### Technical Problem

However, since the conventional studies based on the PET or P3P are for protecting user's privacy in transactions between a user and a service provider, there is a problem in view of protection of privacy on transactions details from a transactions certification institution. Additionally, the above publication provides an anonymous service to conceal the user's identification, but cannot protect privacy on the translations details.

### Technical Solution

The present invention provides a transactions certification method and system to protect privacy of a client by preventing a transactions certification institution from identifying which client has conducted transactions, the transactions certification institution storing transactions details of the client which are supplied from a service provider server.

### Advantageous Effects

Thus, the method and system are convenient for managing the transactions details by enabling the client to inquire about the transactions details at any time.

### DESCRIPTION OF DRAWINGS

FIG. 1 is a block diagram of a transactions certification system to protect privacy on details of electronic transactions Herding to an exemplary embodiment of the present invention.

FIG. 2 is a flowchart of a transactions certification method to protect privacy on details of electronic transactions according to another exemplary embodiment of the present invention.

FIG. 3 is a flowchart showing in detail the procedure of registering the client information with the transactions certification institution server of FIG. 2.

FIG. 4 is a is a flowchart showing procedures of how the client generates the client information and sends the generated information to the transactions certification institution server 120 with respect to the operation S300 of FIG. 3.

FIG. 5 is a flowchart showing in detail procedures of receiving the transactions details of the client with respect to the operation S220 of FIG. 2.

FIG. 6 is a flowchart showing in detail procedures that the service provider server receives the client transactions identifier with respect to the operation S500 of FIG. 5.

### EXPLANATION OF REFERENCE NUMERALS DESIGNATING THE MAJOR ELEMENTS OF THE DRAWINGS

100: Service provider server
120: Transactions certification institution server
140: Client

### BEST MODE

According to an aspect of the present invention, there is provided a transactions certification method to protect privacy on details of transactions conducted between a service provider server and a client in a transactions certification institution server, the transactions certification method comprising the operations of: a) receiving and registering client information which is encoded so that a client cannot be identified; b) receiving and storing transactions details of a client including a client transactions identifier encoded by the service provider server; c) after receiving client certification information for client certification, performing client certification by comparing the client information previously registered in the operation a) with the received client certification information; d) receiving a client transactions identifier for searching transactions details of a client when the client certification is performed in the operation c), and determining whether the client transactions identifier and the client transactions identifier previously stored in the operation b) are identical with each other; and e) generating a message corresponding to the transactions details of the client and sending the generated message to the client when it is determined that the client transactions identifiers are identical with each other in the operation d).

According to another aspect of the present invention, there is provided a transactions certification system to protect privacy on details of transactions conducted between a service provider server and a client in a transactions certification institution server, the transactions certification system comprising: a client registering unit receiving client information, which is encoded such that the client cannot be identified, from the client and registering the received client information; a transactions details collecting unit receiving transactions details of the client which include an encoded client transactions identifier from the service provider server; a storage management unit storing the client information received from the client and the transactions details of the client received from the service provider server; a client certification unit certifying the client after receiving client certification information from the client; and a transactions details searching unit receiving a client transactions identifier from the client for searching the transactions details of the client, searching the received client transactions identifier and a client transactions identifier stored in the storage management unit, and processing the transactions details of the client.

### Mode for Invention

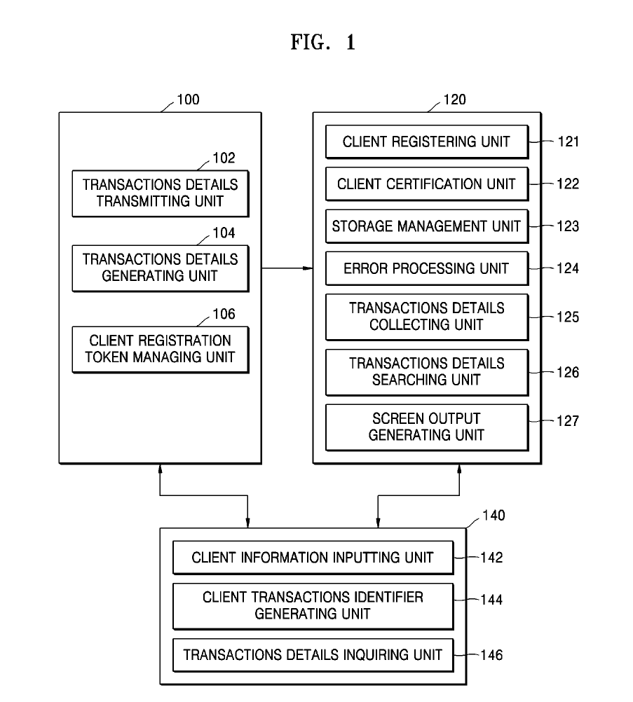

FIG. 1 is a block diagram of a transactions certification system to protect privacy on details of electronic transactions according to an exemplary embodiment of the present invention. The transactions certification system includes a service provider server 100, a transactions certification institution server 120, and a client 140.

The client 140 includes a client information inputting unit 142, a client transactions identifier generating unit 144, and a transactions details inquiring unit 146.

The transactions certification institution server 120 is composed of a client registering unit 121, a client certification unit 122, a storage management unit 123, an error processing unit 124, a transactions details collecting unit 125, a transactions details searching unit 126, and screen output generating unit 127.

The service provider server 100 includes a transactions details transmitting unit 102, a transactions details generating unit 104, and a client registration token managing unit 106.

Each unit is described in detail below.

The client 140 registers client information for certification with the transactions certification institution server 120 in advance such that a user can inquire about transactions details of the client 140 through the service provider server 100.

Further, in the client 140, the client information inputting unit 142 receives a client identifier and a password when the client information is registered with or certified by the transactions certification institution server 120, the client transactions identifier generating unit 144 generates a client transactions identifier for the transactions and the transactions details inquiring unit 146 inquires the transactions details of the client.

The service provider server 100 generates the transactions details about using services by the client 140 and delivers the generated transactions details to the transactions certification institution server 120.

More particularly, in the service provider server 100, the transactions details generating unit 104 generates the transactions details about using services by the client 140, and the transactions details transmitting unit 102 delivers the transactions details to a transactions certification institution server 120.

The transactions certification institution server 120 receives the client information from the client 140 and registers it, receives the transactions details of the client from the service provider server 100 and stores them, and receives the client certification information from the client 140 and determines whether the registered client information is certified by comparing the client certification information and the registered client information. When it is determined that the client information is certified, the transactions details of the client 140 can be to be inquired of.

Further, in the transactions certification institution server 120, the client registering unit 121 registers a client 140, the client certification unit 122 certifies the client, the storage management unit 123 stores the client information and transactions details of the client, the error processing unit 124 handles errors, the transactions details collecting unit 125 receives the transactions details of the client from the service provider server 100, the transactions details searching unit 126 processes the transactions details of the client which the client 140 inquires, and the screen output generating unit 127 creates messages to output the processed result of each unit on a screen.

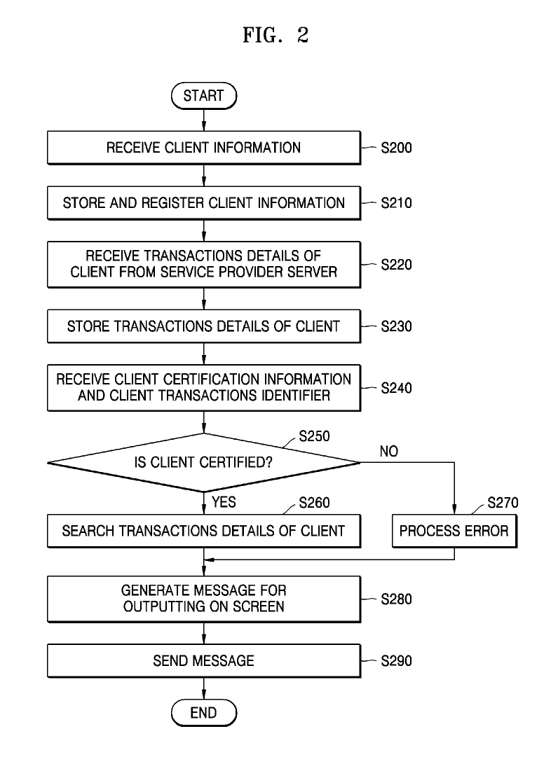

Detailed functions of units of the transactions certification system illustrated in FIG. 1 are now described more specifically with reference to FIGS. 2 through 6.

FIG. 2 is a flowchart of a transactions certification method to protect privacy on details of electronic transactions according to an exemplary embodiment of the present invention.

Referring to FIG. 2, first, the transactions certification institution server 120 receives client information from the client 140 (operation S200).

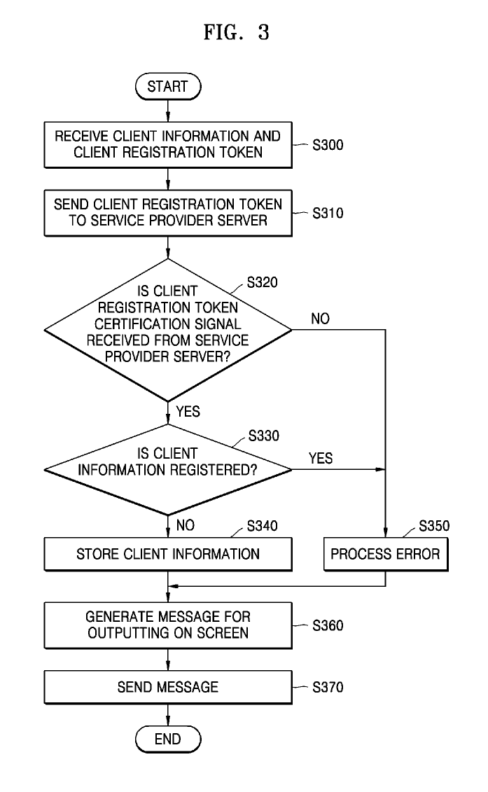

Next, the transactions certification institution server 120 determines whether the received client information is previously registered in the storage management unit 123, and registers the received client information when it is determined that the client information is not previously registered (operation S210). The procedure of receiving and registering the client information in the operations S200 and S210 will be more specifically described with reference to FIG. 3.

Then, the transactions details collecting unit 125 in the transactions certification institution server 120 receives the transactions details of the client from the service provider server 100 (operation S220). The procedure of receiving the transactions details of the client will be more specifically described with reference to FIG. 5.

The transactions details of the client received by the transactions details collecting unit 125 of the transactions certification institution server 120 are stored in the storage management unit 123 (operation S230).

Thereafter, the transactions certification server 120 receives a client identifier UserIdTCA and a hash value of password UserPWTCA used as client certification information from the client 140, and a client transactions identifier Hash(UserIdTCA∥Hash(UserPWTCA∥UserCONSTANT)) used to confirm the transactions details of the client (operation S240).

Then, it is determined whether the client certification is performed by comparing the client certification information which is received through the client certification unit 122 of the transactions certification institution server 120 in the operation S240 with the information previously stored and registered in the storage management unit 123 (operation S250).

If it is determined in the operation S250 that the client certification is not performed, the procedure goes to the operation S270 in which the error processing unit 124 handles the error.

Meanwhile, when it is determined in the operation S250 that the client certification is performed, the procedure goes to the operation S260 in which the transactions details searching unit 126 of the transactions certification institution server 100 searches the transactions details of the client previously stored in the storage management unit 123 by using the client transactions identifier Hash(UserIdTCA∥Hash(UserPWTCA∥UserCONSTANT)).

After the operation S260 or S270, the screen output generating unit 127 creates a message corresponding to each of the operations S260 and S270 to output it on a display device of the client 140 (operation S280).

Next, the transactions certification institution server 120 sends the created message to the client 140 (operation S290). The client 140 receives and displays the message corresponding to each operation on the display device. For example, the message corresponding to the operation S260 may be displayed as ‘Mr. John Doe purchased a mobile phone on 1 Jul. 2004.’ or the message corresponding to the operation S270 may be displayed as ‘User certification has failed.’ Besides, various messages can be displayed.

The transactions details of the client may include the date and time when the client conducts the transactions by using a service, a service provider which supplies the service, a party concerned in the transactions, which is indicated by the client transactions identifier, a transactions object which is the service the client used, and a transactions condition which is a condition of use of the service for the client. These details are described as examples, and various items can be included in the details.

FIG. 3 is a flowchart in detail showing the procedure of registering the client information with the transactions certification institution server of FIG. 2. The client registering unit 121 of the transactions certification institution server 120 manages to register the client information with the transactions certification institution server 120.

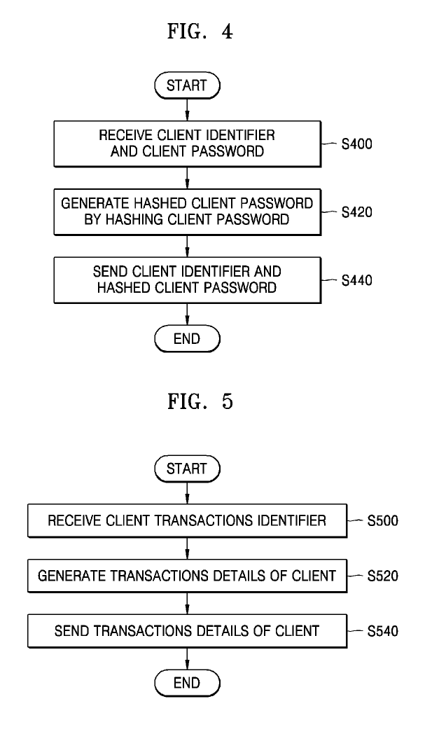

Referring to FIG. 3, the transactions certification institution server 120 receives the client information and a client registration token from the client 140 (operation S300). The client information received from the client 140 will be described in detail with reference to FIG. 4. The client registration token, which is used for certification, is provided to the client 140 from the service provider server 100 in order to permit the client 140 that has been authorized to use the transactions certification institution server 120 before the client 140 registers the client information with the transactions certification institution server 120. Only a user who normally conducts transactions with a service provider server is allowed to register with the transactions certification institution server by using the client registration token, hence preventing other users from registering with the transactions certification institution server.

Then, the transactions certification institution server 120 transmits the client registration token to the service provider server 100. The client registration token managing unit 106 of the service provider server 100 determines whether the received client registration token is identical with the client registration token which the client registration token managing unit 106 previously provided to the client 140, and generates a client registration token certification signal when the client registration token is determined to be an authorized one.

The transactions certification institution server 120 determines whether the client registration token certification signal is received from the service provider server 100 (operation S320).

When it is determined that the client registration token certification signal is not received, the procedure goes to the operation S350 in which the error processing unit 124 handles an error. On the other hand, when it is determined that the signal is received, the procedure goes to the operation S330.

The transactions certification institution server 120 determines whether the client information is previously registered in the storage management unit 123 (operation S330).

When it is determined that the received client information is previously registered in the storage management unit 123 of the transactions certification institution server 120, the procedure proceeds to the operation S350 in which the error processing unit 124 handles an error. Meanwhile, when it is determined that the received client information is not previously registered in the storage management unit 123 of the transactions certification institution server 120, the procedure goes to the operation S340 in which the received client information is stored and registered in the storage management unit 123.

After the operation S340 or S350, the screen output generating unit 127 creates a message corresponding to each operation S340 and S350 to be output on the display device of the client 140 (operation S360).

Then, the transactions certification institution server 120 sends the created message to the client 140 (operation S370). The client 140 receives the message and displays the message corresponding to each operation via the display device of the client 140. For example, the message corresponding to the operation S340 is displayed as ‘Thank you for your registration.’ or the message corresponding to the operation S350 is displayed as ‘You have already registered.’ or ‘This is not an authorized client.’ Such messages are various to be displayed.

FIG. 4 is a flowchart showing procedures of how the client 140 generates the client information and sends the generated information to the transactions certification institution server 120 with respect to the operation S300 of FIG. 3. The client information which the client 140 registers with the transactions certification institution server 120 includes a client identifier UserIdTCA and a hashed client password Hash(UserPWTCA).

Referring to FIG. 4, first, the client information inputting unit 142 of the client 140 receives the client identifier UserIdTCA and a client password UserPWTCA which are input by a user through an input device (operation S400).

Next, the client 140 hashes the client password UserPWTCA to generate the hashed client password Hash(UserPWTCA) (operation S420).

The client 140 sends the client information including the client identifier UserIdTCA and the hashed client password Hash(UserPWTCA) to the transactions certification institution server 120 (operation S440).

In the operation 300 of FIG. 3, the transactions certification institution server 120 receives the client information as shown in FIG. 4.

FIG. 5 is a flowchart showing in detail procedures of receiving the transactions details of the client with respect to the operation S220 of FIG. 2.

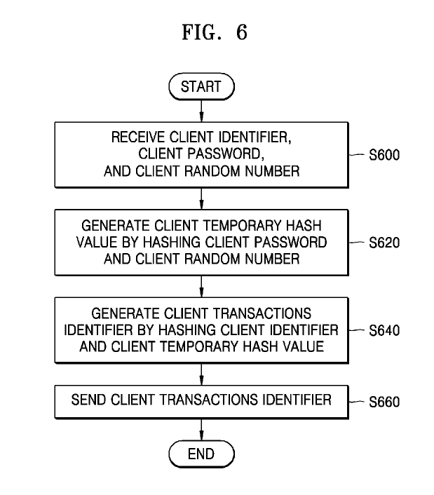

Referring to FIG. 5, the service provider server 100 receives the client transactions identifier from the client 140 (operation S500). The client transactions identifier received from the client 140 will be described in detail with reference to FIG. 6.

Then, the service provider server 100 generates the transactions details of the client 140 through the transactions details generating unit 104 awarding to client's mode of using the service (operation S520).

The service provider server 100 transmits the generated transactions details to the transactions certification institution server 120 through the transactions details transmitting unit 102 (operation S540).

In the operation S220 of FIG. 2, the transactions certification institution server 120 receives the transactions details of the client 140 as shown in FIG. 5.

When the service provider server 100 receives the client transactions identifier (operation S500) and transmits the generated transactions details of the client 140 to the client 140 (operation S540), the client and the transactions certification institution generates SSL which is an encoding channel using a public key certificate to receive data. Accordingly, the client transactions details identifier and the transactions details of the client are prevented from being exposed to the outside.

FIG. 6 is a flowchart showing in detail procedures that the service provider server 100 receives the client transactions identifier with respect to the operation S500 of FIG. 5.

Referring to FIG. 6, the client information inputting unit 142 of the client 140 receives the client identifier UserIdTCA, the client password UserPWTCA, and a client random number UserCONSTANT which the user input through the input device (operation S600).

The client transactions identifier generating unit 144 of the client 140 hashes the received client password UserPWTCA and the client random number UserCONSTANT to generate a client temporary hash value Hash(UserPWTCA∥UserCONSTANT) (operation S620).

Next, the client transactions identifier generating unit 144 of the client 140 hashes the client identifier UserIdTCA and the client temporary hash value Hash(UserPWTCA∥UserCONSTANT) again to generate the client transactions identifier Hash(UserIdTCA∥Hash(UserPWTCA∥UserCONSTANT)) (operation S640).

Then, the client 140 transmits the client transactions identifier Hash(UserIdTCA∥Hash(UserPWTCA∥UserCONSTANT)) to the service provider server 100.

In the operation S500 of FIG. 5, the service provider server 100 receives the client transactions identifier as shown in FIG. 6.

According to the exemplary embodiment, by using the client transactions identifier, which is generated by hashing the client identifier and the client password and client random number which only the client 140 knows the transactions certification institution server 120 cannot identify the client 140 which conducted the transactions. As such the client's privacy is protected, and the client 140 can easily inquire about the transactions details.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the appended claims.

### INDUSTRIAL APPLICABILITY

According to the transactions certification method and system to protect privacy on details of electronic transactions, since client information includes only a basic identifier and encoded password for client certification, the transactions certification institution server cannot identify which client conducted transactions from the transactions details managed by the transactions certification institution server, and therefore, user's privacy can be protected. Further, since the user that has used various services stores the transactions details about the used services in a server of the transactions certification institution, which is a trusted third party, the user can easily manage the transactions details of the used services.

1. A transactions certification method to protect privacy on details of transactions conducted between a service provider server and a client in a transactions certification institution server, the transactions certification method comprising the operations of:
a) receiving and registering client information which is encoded so that a client cannot be identified;
b) receiving and storing transactions details of a client including a client transactions identifier encoded by the service provider server;
c) after receiving client certification information for client certification, performing client certification by comparing the client information previously registered in the operation a) with the received client certification information;
d) receiving a client transactions identifier for searching transactions details of a client when the client certification is performed in the operation c), and determining whether the client transactions identifier and the client transactions identifier previously stored in the operation b) are identical with each other; and
e) generating a message corresponding to the transactions details of the client and sending the generated message to the client when it is determined that the client transactions identifiers are identical with each other in the operation d).

2. The transactions certification method of claim 1, wherein the client information is generated by hashing the client identifier and a client password which are received from the client.

3. The transactions certification method of claim 2, further comprising the operation of:
receiving a client registration token which is provided from the service provider server to the client.

4. The transactions certification method of claim 3, wherein the operation of receiving and registering the client information includes the operations of:
a-1) receiving the client identifier, a hashed client password generated by hashing a client password and a client registration token from the client;
a-2) sending the client registration token to the service provider server;
a-3) receiving a result signal indicating that the client registration token is authorized from the service provider server;
a-4) determining whether the client identifier and the hashed client password generated by hashing a client password are previously registered; and
a-5) registering the client identifier and the hashed client password generated by hashing a client password when the result signal is received in the operation a-3) and it is determined that the client identifier and the hashed client password are not previously registered.

5. The transactions certification method of claim 1, wherein the operation of receiving the client transactions details of the client from the service provider server includes the operations of:
receiving the client transactions identifier by the service provider server from the client;
generating client transactions details which include the received client transactions identifier by the service provider server; and
sending the generated transactions details of the client from the service provider server to the transactions certificating institute server.

6. The transactions certification method of claim 5, wherein the operation of receiving the client transactions identifier by the service provider server from the client includes the operations of:
receiving a client identifier, a client password, and a client random number by the client;
generating a client transactions identifier by the client combining the client identifier, the client password and the client random number; and
sending the generated client transactions identifier from the client to the service provider server.

7. The transactions certification method of claim 1, wherein the client certification information includes a client identifier and a hashed client password generated by hashing a client password.

8. A transactions certification system to protect privacy on details of transactions conducted between a service provider server and a client in a transactions certification institution server, the transactions certification system comprising:
a client registering unit receiving client information, which is encoded such that the client cannot be identified, from the client and registering the received client information;
a transactions details collecting unit receiving transactions details of the client which include an encoded client transactions identifier from the service provider server;
a storage management unit storing the client information received from the client and the transactions details of the client received from the service provider server;
a client certification unit certifying the client after receiving client certification information from the client; and
a transactions details searching unit receiving a client transactions identifier from the client for searching the transactions details of the client, searching the received client transactions identifier and a client transactions identifier stored in the storage management unit, and processing the transactions details of the client.

9. The transactions certification system of claim 8, wherein the service provider server includes:
a transactions details generating unit receiving an encoded client transactions identifier from the client and generating transactions details of the client which include the encoded client transactions identifier; and
a transactions details transmitting unit delivering the generated transactions details of the client to the transactions certification authority institution server.

10. The transactions certification system of claim 9, wherein the service provider server further includes a client registration token managing unit sending a client registration token to the client and sending a result signal to the transactions certification institution server for indicating that the client registration token is authorized.

11. The transactions certification system of claim 9, wherein the client transactions identifier is generated by the client which receives and combines a client identifier, a client password and client random number.

12. The transactions certification system of claim 8, wherein the transactions certification institution server further includes:
an error processing unit handling an error when it is determined that client information is previously registered in the client registering unit or when the client is not certified in the client certification unit; and
a screen output generating unit generating a message for outputting a processed result of each unit of the transaction certification institution server on a screen.
